(19) United States
(12) Patent Application Publication
(10) Pub. No.: US 2014/0195862 A1
(43) Pub. Date: Jul. 10, 2014

(54) SOFTWARE SYSTEMS BY MINIMIZING ERROR RECOVERY LOGIC

(71) Applicant: MICROSOFT CORPORATION, Redmond, WA (US)

(72) Inventors: Martin Taillefer, Redmond, WA (US); Jinsong Yu, Bellevue, WA (US); John J. Duffy, Seattle, WA (US); Sean E. Trowbridge, Redmond, WA (US); Alexander D. Bromfield, Seattle, WA (US)

(73) Assignee: MICROSOFT CORPORATION, Redmond, WA (US)

(21) Appl. No.: 13/734,700

(22) Filed: Jan. 4, 2013

(51) Int. Cl. G06F 11/07

(52) U.S. Cl. CPC G06F 11/0772
USPC 714/48

(57) ABSTRACT

Handing errors in program execution. The method includes identifying a set including a plurality of explicitly identified failure conditions. The method further includes determining that one or more of the explicitly identified failure conditions has occurred. As a result, the method further includes halting a predetermined first execution scope of computing, and notifying another scope of computing of the failure condition. An alternative embodiment may be practiced in a computing environment, and includes a method handing errors. The method includes identifying a set including a plurality of explicitly identified failure conditions. The method further includes determining that an error condition has occurred that is not in the set including a plurality of explicitly identified failure conditions. As a result, the method further includes halting a predetermined first execution scope of computing, and notifying another scope of computing of the failure condition.

### BACKGROUND

### Background and Relevant Art

Computers and computing systems have affected nearly every aspect of modern living. Computers are generally involved in work, recreation, healthcare, transportation, entertainment, household management, etc. Computer functionality is typically the result of computing systems executing software code.

A substantial portion of modern software code is dedicated to discovering, reporting, and recovering from error conditions. In real-world scenarios, error conditions are relatively rare and are often difficult to simulate, yet programmers devote a substantial amount of resources to dealing with them.

Within software systems, a disproportionate number of bugs exist in error recovery code as compared to the total code in these systems. This directly correlates to the fact error conditions are often difficult to simulate and as a result often go untested until a customer encounters the underlying issue in the field. Improper error recovery logic can lead to compound errors and ultimately to crashes and data corruption.

Traditional software systems comingle different types of error conditions and provide a single mechanism for dealing with these error conditions. This uniformity is appealing on the surface as it allows developers to reason about error conditions in a single consistent way for the system. Unfortunately, this uniformity obfuscates qualitative differences in errors.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment may be a method practiced in a computing environment with acts for handing errors. The method includes identifying a set including a plurality of explicitly identified failure conditions. The method further includes determining that one or more of the explicitly identified failure conditions has occurred. As a result, the method further includes halting a predetermined first execution scope of computing, and notifying another scope of computing of the failure condition.

An alternative embodiment may be practiced in a computing environment, and includes a method for handling errors. The method includes identifying a set including a plurality of explicitly identified failure conditions. The method further includes determining that an error condition has occurred that is not in the set including a plurality of explicitly identified failure conditions. As a result, the method further includes halting a predetermined first execution scope of computing, and notifying another scope of computing of the error condition.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing scope of execution;

FIG. 2 illustrates a body of code and compiling the code with a compiler;

FIG. 3 illustrates a managed code system;

FIG. 4 illustrates a method of handling errors; and

FIG. 5 illustrates another method of handling errors.

### DETAILED DESCRIPTION

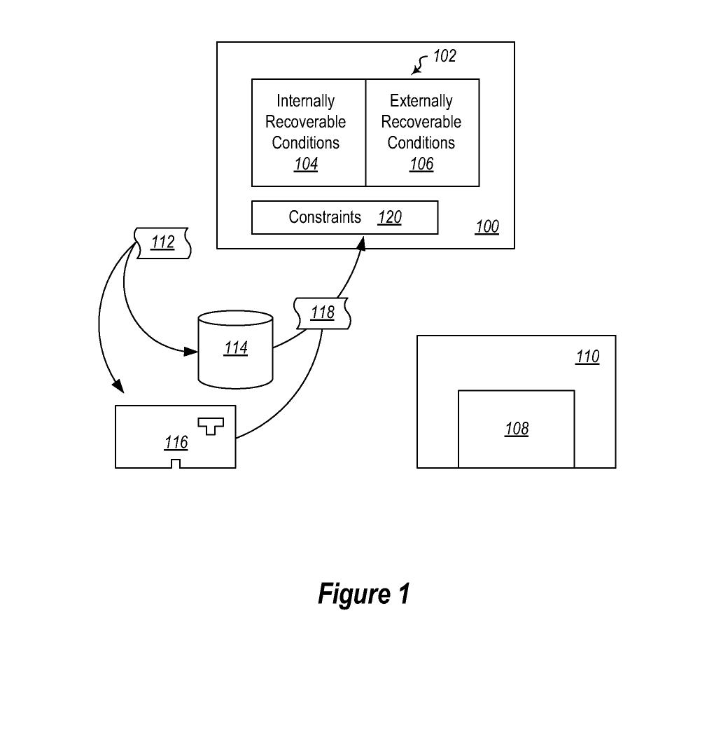

Embodiments explicitly partition all failure conditions into what are deemed “expected” and “unexpected”. Software is expected to recover in situ from expected failures, while unexpected failures are handled externally. This is done because by definition the failures are unexpected and the software is not prepared for the failure. Embodiments may include one or more of a number of different mechanisms to make it possible for a software environment to systematically identify which failures are expected and which are not such that the right disposition can take place. With reference to FIG. 1, embodiments may partition the entire set 102 of error conditions occurring within a software execution scope 100 into two types and provide specialized mechanisms to deal with each type. In so doing, embodiments derive a number of benefits ranging from improved correctness to improved performance. With reference to FIG. 1, the two broad types of error conditions embodiments recognize are internally recoverable conditions 104 and externally recoverable conditions 106.

Internally recoverable conditions 104 are error conditions which a software execution scope 100 is capable of reliably discovering and recovering from within the local scope of a computation. These errors originate from two broad sources: I/O failures and semantic failures.

Externally recoverable conditions 106 are conditions for which embodiments determine that software is ill-equipped to deal with in-situ and thus are dealt with by an external agent 108. Externally-recoverable error conditions generally originate from two broad sources: software defects (i.e. bugs) and meta-failures (e.g. inability to allocate memory). A meta-failure is a failure which is not directly related to the semantic of a computation and is the result of a constraint in a virtual environment that the computation executes in. For example, a computation expects to have a stack onto which it can push local variables. If a virtual environment imposes a limit to the depth of a stack, a computation is generally unable to predict when this limit will occur and has no recovery path possible when such a limit is reached. Similarly, computations typically expect to be able to allocate memory and the inability to obtain new memory is a meta-failure.

When such errors occur, the computational scope 100 in which the error occurred has been somehow compromised and is therefore incapable of tending to the error conditions and recovering from it. The error handling is thus left to an external agent 108 which operates in an uncompromised scope 110. For example, in the inability to allocate memory case, asking an agent in the original computational scope 100 that cannot allocate memory to begin a recovery algorithm may often result in the agent trying to allocate memory to perform the recovery algorithm. This makes little sense. Rather, an external agent 108 that is able to allocate memory or that already has memory allocated for recovery may be better able to handle the error.

A common response to “out of memory” is in fact to forego the operation completely. Whereas in traditional systems code that experiences an out of memory condition necessarily contains a substantial number of error checks and extensive backout logic to clean up in case of failure, in embodiments herein the code can be written as if allocation will always succeed. If an allocation does fail, then embodiments immediately stop running any more code and defer to another context which can then to treat the whole operation as having failed.

A substantial amount of code in traditional systems exists to provide fundamentally unsound local runtime detection, reporting, and recovery of error conditions. This code can occasionally succeed, but it is frequently an exercise in futility. Some embodiments disclosed herein systematically forego this code, resulting in considerably shorter source code not burdened with error-prone back-out logic.

Embodiments combine a number of techniques to systematically partition error conditions in the above two types, and to enable programmers to reason explicitly about which code can and cannot fail. By systematically applying these techniques, embodiments derive considerable correctness, performance, and development time benefits.

The following illustrates a brief summary of several of the aspects of one or more of the various embodiments disclosed herein. Embodiments, as described above, may implement error type partitioning. Embodiments may systematically divide all error conditions into internally recoverable errors 104 and externally recoverable errors 106 and apply explicitly different disposition policies to each.

Embodiments may implement a concept referred to herein as abandonment. Abandonment is a mechanism to immediately suspend execution of a computation within a corrupted scope, such as for example the software execution scope 100. An operating system process serves as a typical abandonment context scope but, as illustrated in more detail below, others are possible. When abandonment occurs, no additional code executes within the computation's scope, preventing further corruption from being introduced and allowing an external agent to attempt recovery instead.

Embodiments may implement holistic contracts with abandonment. Systems may define a contract-based design methodology. Some embodiments disclosed herein introduce the use of contracts in an operating system, leveraging contracts to define all operating system interfaces in addition to using contracts within its implementation. A contract defines a set of static invariant requirements that a logical agent requires. For example, a contract may define acceptable inputs into the logical agent. If any of the static invariant requirements are not met, the contract is violated. Embodiments extend the classic contract model by treating contract violations as being situations which cannot be rectified by the violator or the logical agent to which the contract applies, which makes such violations into externally recoverable errors 106.

Embodiments may implement a managed runtime with abandonment. Whereas traditional managed language systems, such as Java and C#, rely on exceptions to report runtime-level failures, such as array-access-out-of-bounds, null-dereference, or out of memory conditions, embodiments treat all such occurrences as violations of the runtime's contract preconditions leading to abandonment.

Embodiments may implement memory exhaustion with abandonment. Whereas traditional systems attempt to systematically report all forms of memory exhaustion to the programmer, some embodiments disclosed herein treat such occurrences as not being recoverable internally and hence they are only externally recoverable errors 106 that lead to abandonment of the current computation.

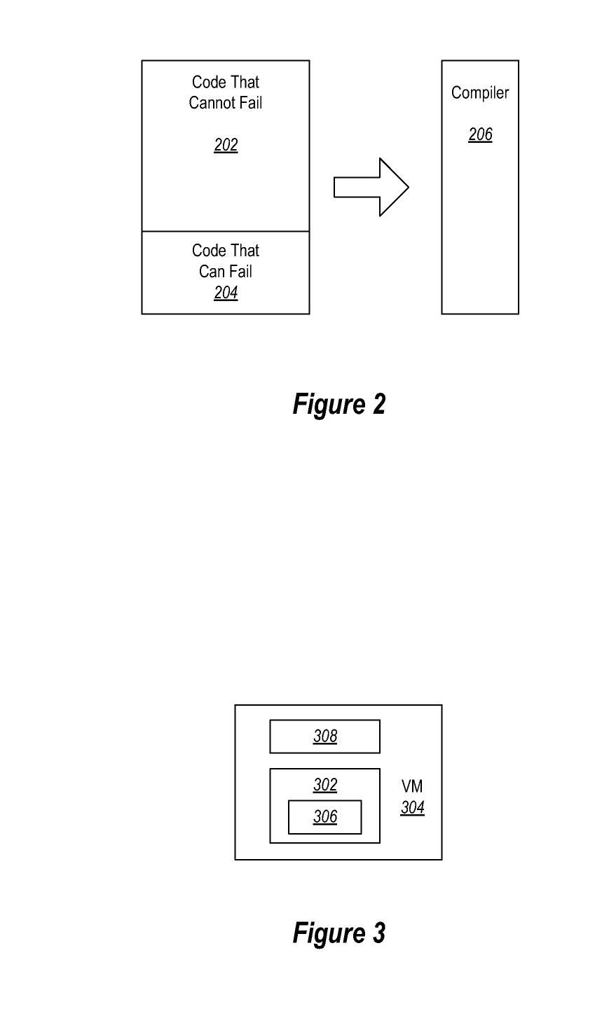

Embodiments may implement an exception effect system for internally recoverable error conditions. Using the above mechanisms embodiments may dramatically reduce the amount of software which needs recovery logic for internally recoverable error conditions. This makes it possible to introduce an effect system to make it explicit to the programmer and compiler which methods and code blocks can experience recoverable errors as illustrated by the code that cannot fail 202 in FIG. 2 and which cannot as illustrated by the code that can fail 204 illustrated in FIG. 2. In some embodiments, methods and code blocks can be annotated with metadata indicating whether or not it can recover internally. This enables large call graphs within system and application code to be written with the assumption of no internal errors. This makes the affected code considerably easier to write and reason about, and improves the ability for static analysis to discover flaws in the software that could lead to externally recoverable error conditions 106. The following illustrates a code annotation example. This example shows that methods can be declared as throwing exceptions. When not so annotated, a method cannot throw exceptions and hence doesn't experience or induce any internally recoverable errors. As a result, calls to the method are treated as infallible and require no error recovery logic. M2 however is annotated as throwing, and hence calls to this method must necessarily be preceded by the ‘try’ keyword to indicate to the programmer a potential point of failure. In addition, since the call can fail, error recovery logic is necessary which is contained in the catch clause.

// a method that doesn't produce recoverable errors
void M1( )
{
}
// a method that may produce recoverable errors
throws void M2( )
{
}
...
{

// this call can not fail
M1( );
try {

// this call can fail, as denoted by the ‘try’ keyword
try M2( );

}
Catch {

// implement recovery logic for M2's failure

}

}

Embodiments may experience improved performance. Compilers derive opportunities for optimizations by leveraging the specific semantics of abandonment and of the exception effect system. In addition, there is less developer-written code in hot paths which tends to improve the effectiveness of microprocessor instruction caches.

Additional details are now illustrated.

The distinction between internally recoverable error conditions 104 and externally recoverable error conditions 106 defines how some embodiments disclosed herein are built. Embodiments recognize this duality at different levels of the system and leverage it as a guiding principle when factoring system functionality.

Internally recoverable error conditions 104 arise from two broad sources. One is from I/O failures. Computer systems perform I/O operations 112 to external devices such as hard disks 114 or network adapters 116 and such operations 112 are inherently fallible. Disk drives 114 can fail, network cables can be disconnected, etc. I/O operations 112 are typically performed in a software system at a fairly coarse level, lending them to error recovery logic.

The second source of internally recoverable errors is semantic failures. These occur following an I/O operation 112 when new data 118 has entered the system. The shape and size of incoming data 118 is usually subject to a variety of constraints 120 and when these constraints 120 are violated, a semantic failure has occurred. Like I/O failures, semantic failures are an expected part of consuming any data and software is generally well-equipped to discover, report, and recover from them.

To reliably recover from I/O failures or semantic failures, in some embodiments, the software assumes that meta-failures and software defects do not exist. Software is considered to be defective when it does not behave according to expectations. Defects can become apparent to the user of the software by virtue of unexpected termination of the software (i.e. a crash) or through erroneous output of some form. Software may discover defects itself by establishing that certain invariants must hold and verifying that they are indeed holding throughout the execution of the software. It is logically inconsistent to assume that one can write robust recovery logic when the recovery logic itself is subject to failures which it cannot control.

An externally recoverable error condition 106 is one which is either due to a bug in the software or due to an environmental issue beyond the control of the computation or software execution scope 100 experiencing the error. The error condition is handled externally by an external agent 108 as the error has left the software execution scope 100 in a fundamentally compromised state and hence is logically unable to recover by itself. Traditional systems routinely allow such compromised computations to try to recover from errors, which leads to the meta-stability issues endemic to modern large scale software systems.

Software systems include various forms of empirical validation of conditions believed to be true at any one point in time during the life of the system, i.e. the invariants described above. When such validation fails, it indicates that a bug in the software has been detected. As there is nothing a computation can do to recover from bugs in its own code, embodiments deem such situations as only being externally recoverable conditions 106.

Referring now to FIG. 3, managed environments execute software 302 on top of a virtual machine 304. The virtual machine 304 can experience failures which are completely unrelated to the semantics of the computation 306 being executed. Embodiments call these meta-failures. For example, a JIT compiler 308 may run out of memory when trying to dynamically compile part of a computation's code. Such failures defy internal recovery as the programmer is unable to reason about the state of the virtual machine 304. Any recovery code could itself be subject to the same failures.

Internally recoverable error conditions 104 can benefit from great precision. Semantically, programmers can often understand exactly what lead to the error. In contrast, externally recoverable error conditions 106 are imprecise by nature. When a computation encounters an externally recoverable error condition 106, the computation (running in an execution scope 100) is terminated through abandonment and a distinct computation (e.g. an external agent 108) is notified and expected to perform recovery tasks. As it does so, the external computation is often only aware of the top-level inputs to the abandoned computation and is not privy to the specific cause of the error.

The loss of precision is actually helpful in reducing the amount of error handling logic and to improve its quality. Embodiments replace a large amount of fine-grained internal error discovery, reporting, and recovery logic with coarse external logic instead. This leads to a considerable reduction in the amount of source code written and is inherently much easier for developers to reason about.

Fundamentally, as developers write code it is nearly impossible to reason about all possible failures and all possible recovery strategies. Traditional managed environment make it so nearly every program statement is susceptible to occasional failure and humans just cannot think in these terms. Some embodiments disclosed herein dramatically reduce the amount of recovery logic that needs to be written, and instead requires it be written to execute in a context which is known to be reliable.

Contrasting Error Types

This table illustrates the differences between the two error types embodiments may define:

| | Internally Recoverable | |
|---|---|---|
| | Errors | Externally Recoverable Errors |
| Exemplary | I/O Failures | Software Defects |
| Origin | Cannot find a file | Contract violation |
| | Network | Runtime violation |
| | connection lost | Meta Failures |
| | Child Process | Memory exhaustion |
| | abandonment | Stack overflow |
| | Semantic Failures | |
| | Invalid file format | |
| | Invalid user input | |
| Computation | Normal, can continue | Compromised, should stop |
| State | executing | executing |
| Frequency | Common and expected in | Rare, signs of something bad |
| | normal systems. | happening. |
| Programming | Exception effect system. | Contracts |
| Constructs | | Preconditions |
| | | Postconditions |
| | | Assertions |

Abandonment represents the immediate and irreversible cessation of activity within a specific execution scope 100. An execution scope 100 is defined as a closed set of memory locations reachable from a computation running inside the scope. Execution scopes may be of various different granularities. For example, an execution scope may be a process and hence abandonment leads to process termination. Alternatively, an execution scope may be a group of processes such that embodiments can abandon the group of processes. Alternatively, the execution scope may be the machine on which one or more processes is implemented such that the system as a whole can abandon (leading to a reboot) if a non-recoverable error is encountered. In another alternative example, an execution scope may exist within a process but is not the entire process. In another alternative, the execution scope may be a custom defined scope that crosses traditional execution scopes. When abandonment has occurred, the computation is halted and the execution scope is recycled by the environment.

As illustrated above, in some embodiments, an execution scope is a process. However, a determination of appropriate scope may be whether it is equipped to recover from the failure of another scope. Given some scope A that attempts to respond to the failure of some scope B, the resources used by both A and B are sufficiently isolated that the failure in B will not negatively interfere with the operation of scope A. If that were the case, embodiments may consider the failure to apply to an even larger scope (e.g., the whole machine rather than just a process).

The execution scope 100 involved in abandonment, in some embodiments represents the total set of memory locations that a computation may have mutated from the time an externally recoverable error condition has occurred to the point where the error condition was recognized and abandonment was triggered. By immediately stopping the computation, embodiments prevent corruption from spreading further. When a computation is abandoned, its failure is reported to a distinct computation (illustrated as the external agent 108) within an orthogonal scope 110 unaffected by the mutations of the first scope. This distinct computation is then responsible for deciding upon a recovery course.

Some embodiments may be implemented in an environment with a holistic contract architecture with abandonment. Several software systems use the contract-based design methodology pioneered by the Eiffel programming language available from Eiffel Software of Goleta, Calif. Some embodiments disclosed herein are systematically designed around a contract methodology. In some embodiments, virtually every part of the system is specified and implemented with contract declarations. For example, as illustrated in FIG. 1, the contract may be embodied by the constraints 120. The following illustrates the use of contract preconditions and postconditions to encode constraints in a software system.

// declaring a method
int Compute(int x)

| | |
|---|---|
| requires x > 0 | // a constraint on the caller of the method |
| ensures return != 0 | // a constraint on the implementation of the |

method
{
}
...
{

| // invoking the method | |
|---|---|
| int y = Compute(−1); | // violates the precondition constraint |
| int z = Compue(1); | // satisfies the precondition constraint |

// due to the ‘ensures’ clause above, at this point z is known to be != 0
// (not equal to zero)

}

The contract design methodology enables the programmer to specify constraints 120 on the values and combination of values that individual software abstractions can hold. These constraints 120 complement those already imposed by the type system. For example, a contract precondition can specify that a given method parameter should be in the range of 0 to 31, which is a constraint over all possible values that a normal integer parameter could have.

In typical systems, contract violations result in some form of internally recoverable error condition visible to the computation. For example, in Eiffel contract violations throw exceptions. In some embodiments disclosed herein, embodiments view a contract violation as representing a bug in the software, effectively a disagreement between two components on their mutual obligations. By their nature software bugs are not recoverable in-situ as a programmer may need to be involved to change the source code in some way. As a result, in some embodiments disclosed herein contract violations are treated as only being externally recoverable conditions 106 and hence they lead to abandonment.

The vast majority of correctness checks done in an operating system around application programming interface (API) boundaries are to protect against programmer errors. The operating system does a check for the bad condition and returns a failure indication to the caller. The caller then also does some checks in case the operation failed. All this checking amounts to a lot of code which impacts the readability, the development time, and the performance of the resulting system.

An example of typical C code that demonstrates the double checking is as follows:

BOOL M1(int x)
{

// a check in the implementation
if (x < 0) {

return FALSE;

}
...
return TRUE;

}
void M2( )
{

if (M1(42) == FALSE) {

// another check in the caller

}

}

In some embodiments disclosed herein, code never reasons locally about recovering from contract violations, eliminating that logic from all programs and system code inherently reduces program size and improves performance:

void M1(int x)

requires x >= 0 // a single check

{
}
void M2( )
{

M1(42);

}

As illustrated in FIG. 3, some embodiments implement a managed runtime with abandonment. Managed languages provide safeguards to prevent some unexpected behaviors in software. For example, type safety ensures that pointers always reference valid strongly-typed data. In a typical managed environment such as Java or .NET, attempts by the software to violate a precondition of the managed runtime leads to exceptions. For example, accessing a null pointer or trying to write beyond the bounds of an array will lead to exceptions.

In addition, managed languages also sometimes inject failures at arbitrary points within the execution of a program. For example, in some environments a JIT compiler is used to compile code on-the-fly and if the JIT compiler fails to allocate some memory, it can inject an exception in the computation reflecting that fact.

This general arrangement in effect implies that nearly any statement in a managed program is subject to failure. Any pointer access can lead to a null reference exception, any array access can lead to an out-of-bound exception, and any statement executed can lead to the JIT compiler running out of memory. This makes it practically impossible to reason about the behavior of a complex system. Basically, anything can fail for one or more of a number of different reasons at any time. Even code designed to compensate for failures can also fail at any time for one or more of a number of different reasons.

Using this approach, it is only possible to design software systems that tend to be correct in normal use. It is however nearly impossible to design provably correct systems of any scale.

However, in contrast, in some embodiments disclosed herein, embodiments treat violations of the managed runtime's preconditions as being strictly externally recoverable on par with contract violations. When such violations occur, they are not observable by the affected computation since abandonment is immediately triggered.

Some embodiments disclosed herein address memory exhaustion with abandonment. Memory is a finite resource in a computing environment. In traditional systems, running out of memory is usually reported to the software trying to obtain the memory. In native languages like C, this is done by returning a null pointer, while in managed languages exceptions are thrown.

Programming in a managed environment often leads to a pattern of memory allocations which is very different than that experienced in traditional native environments. This is due to the fact that lifetime management of allocated memory blocks is not an issue in managed code. As a result, there tends to be more frequent points of allocation, and allocations tend to be more ad hoc than in native code. In fact, several constructs in managed languages end up allocating memory at unexpected points by virtue of how the language or the underlying virtual machines are implemented, which makes it hard for the programmer to contend with failures to allocate.

Recovering from out of memory conditions is notoriously difficult and often code that is intended to do so fails in the field due to inherent bugs in the back-out logic. In managed code, the back-out logic itself can often try to allocate some memory which can also fail. In contrast, in some embodiments disclosed herein, embodiments consider memory exhaustion as being an externally recoverable error condition. When a computation runs out of memory, it is abandoned.

The following now illustrates an exception effect system for internally recoverable errors. As a general rule, it is easier to write software if no failures are possible. The programmer does not need to write any error-prone back-out logic and can write more straightforward source code. With reference to FIG. 2, the compiler 206 is also capable of additional optimizations which improve the quality of the resulting compiled code.

As described previously, in a traditional managed environment, nearly every statement can lead to a failure. It is therefore very difficult to reason about the creation of highly-reliable software, and the compiler 206 is burdened with expensive semantics to support.

In contrast, in some embodiments disclosed herein, using the mechanisms described previously, embodiments have systematically removed the vast majority of what can lead to fine-grained failures within software. The vast majority of the associated error conditions are handled via external recovery. What remains is a relatively small set of internally recoverable error conditions.

Given the benefits of error-free programming, embodiments introduce the ability to explicitly annotate software methods or blocks as potentially failing. For example, as illustrated in FIG. 2, portions of code can be annotated as code that can potentially fail 204. The implication here is that software which is not so-annotated can simply not experience an internally recoverable error. As externally recoverable errors are explicitly handled separately from the main logic of a program, embodiments now have the ability for large graphs of computation to be completely devoid of any error logic. This leads to a substantial simplification of the programming experience and to substantial potential for improvements in the quality of compiled code. For example, the following code indicates that M1 can fail by throwing an exception. When this annotation is not present on a method declaration, the method is considered infallible.

throws void M1( )
{

throw new Exception(“This method is failing”);

}
void M2( )
{

try {

try M1( )

}
catch (Exception ex) {
}

}

Creating regions of code that do not observe failures which result in abandonment and implementing constraints that require points of internally recoverable errors be explicitly annotated affords opportunities for the back-end compiler to produce superior machine code by avoiding expensive sequences necessary to propagate exceptions, improving the performance of the resulting program.

The compiler 206 understands the semantics of abandonment. The compiler can take advantage of the fact abandonment immediately stops executing instructions in the existing scope to eliminate redundant control flow. Control flow in a software system represents the sequence of instructions that the processor executes. A processor has an instruction pointer which indicates the address of the next instruction to execute. When the instruction is complete, the processor automatically increases the instruction pointer to indicate the following memory location where the next instruction is located. Certain special instructions exist to alter the control flow. These are unconditional branches, conditional branches, function calls, function returns, and others. The pipelined nature of modern microprocessors is such that they can execute code sequences considerably faster when there are no instructions that modify the naturally sequential control flow of the processor. Eliminating control flow instructions can therefore have a dramatic effect on the total throughput of a microprocessor.

Embodiments have also taught the compiler 206 that abandonment should be considered a rare event and it can use this information to organize code layout accordingly, improving instruction cache efficiency by moving infrequently used code out of line. Software defects can be considered as being an aberration. Hence, abandonment is a rare event in the life of a software system. Many compiler optimizations are enhanced by the knowledge that certain code sequences are ‘hot’ while others are ‘cold’. Hot code sequences are executed frequently in the system while cold code is executed infrequently. Profile Guided Optimization is a common practice where a compiled program is executed in a diagnostic setting such as to observe the dynamic execution of the code. Based on these observations, the program under test is recompiled. This time, the compiler considers the hot/cold information obtained by running the program in order to organize the code it generates appropriately. Profile guided optimization is fundamentally flawed in that the data collected describing the execution pattern of a program is inherently finite, representing only a small percentage of possible executions of the program. Code sequences that lead to abandonment can be treated systematically by a compiler as being cold code. Unlike profile guided optimization, the compiler can rely on this information being always correct in all cases.

The use of contracts eliminates often redundant checking from the main code paths. Around operating system boundaries, parameters are normally checked in the implementation of the API and the caller of the API checks for the failure of the API as a whole. With the contract architecture, the caller-side check is completely redundant and does not need to be written.

The exception effect system enables the compiler 206 to know precisely the regions of code that can throw exceptions and are generally susceptible to internally recoverable errors. As a result, when generating code that is designed to never experience internally recoverable errors, the compiler 206 can avoid generating the more expensive code usually associated with exception handling.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

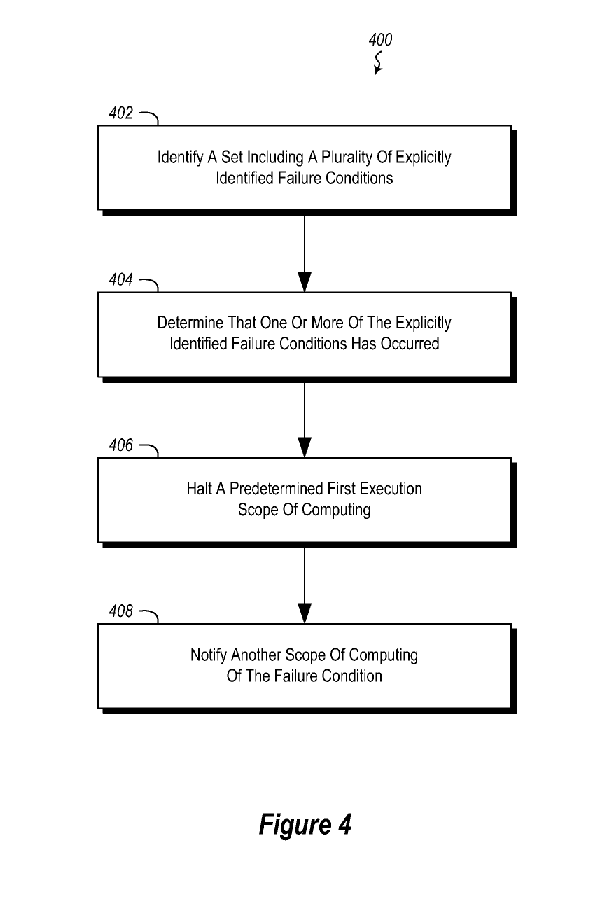

Referring now to FIG. 4, a method 400 is illustrated. The method 400 may be practiced in a computing environment and includes acts for handing errors. The method includes identifying a set including a plurality of explicitly identified failure conditions (act 402). For example, as illustrated in FIG. 1, externally recoverable conditions 106 are illustrated. These are explicitly enumerated in the design by a framework or other entity running an execution scope 100.

The method 400 further includes determining that one or more of the explicitly identified failure conditions has occurred (act 404). For example, a specific point of failure may dictate statically what type of error it is. In other words code may be annotated to indicate “if there is a failure, here, it is always an externally recoverable error, but if there is an error over there then it is inherently an internally recoverable error.” In other words, typically, the point of discovery determines the kind of error it is.

As a result, the method 400 further includes halting a predetermined first execution scope of computing (act 406), and notifying another scope of computing of the failure condition (act 408). For example, in the example, illustrated in FIG. 1, the execution scope 100 may be halted, and the execution scope 110 (and in particular, the agent 108) may be notified of the failure. The external scope may be configured to handle the failure condition.

The method 400 may be practiced where the set including a plurality of explicitly identified failure conditions comprises a failure condition indicating that a static invariant requirement of a computing module has been violated. For example, FIG. 1 illustrates of set of constraints 120. The constraints may be an example of the static invariant requirements. Violation of a constraint typically indicates a bug in software which is best handled by an external agent 108.

The method 400 may further include identifying to a programmer user the set including a plurality of explicitly identified failure conditions to indicate to the programmer user failure conditions that can cause a failure of the first execution scope of computing. In particular, a programmer may be able to access a list of conditions that will cause a failure that is handled by an external agent. Thus, the programmer can program application with this in mind and thus optimize applications for this type of error handling. In particular, the programmer may not need to create as much error handling code in an application because the programmer knows that such errors will be handled by an external agent.

The method 400 may further include identifying to a compiler the set including a plurality of explicitly identified failure conditions to indicate to the compiler failure conditions that can cause a failure of the first execution scope of computing. For example, as illustrated in FIG. 2, a compiler 206 may be aware of code that can fail 204 internally at the scope 100. The compiler 206 can then optimize how a set of code is compiled based on this. For example, some embodiments may include the compiler compiling the predetermined first execution scope of computing in an optimized way based on the identified set. In some embodiments, compiling the predetermined first execution scope of computing in an optimized way based on the identified set including a plurality of explicitly identified failure conditions comprises organizing the code layout of the predetermined first execution scope to improve cache efficiency by moving infrequently used code out of line. Alternatively or additionally, compiling the predetermined first execution scope of computing in an optimized way based on the identified set including a plurality of explicitly identified failure conditions comprises eliminating redundant control flow based on knowledge by the compiler of the conditions that cause halting the predetermined first execution scope of computing.

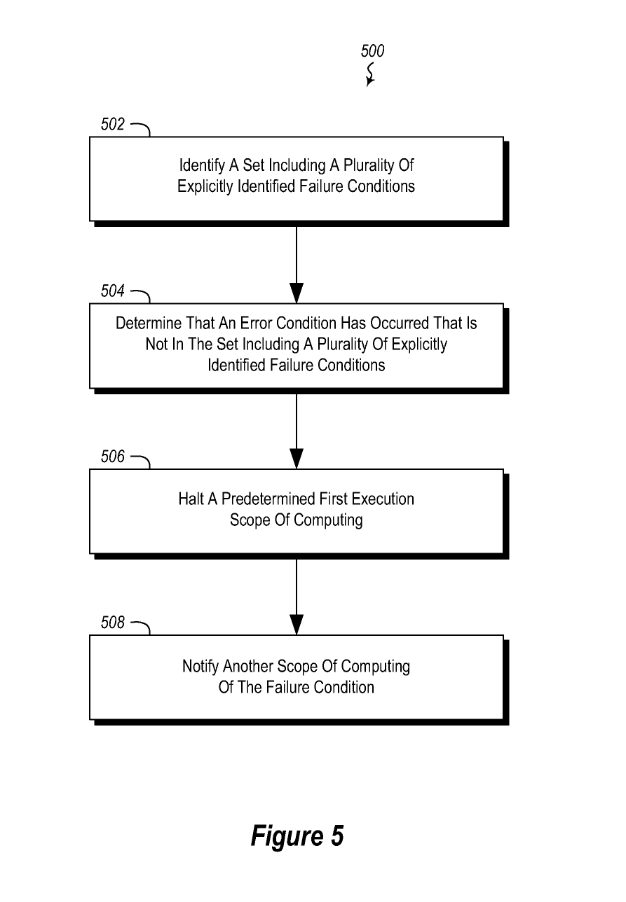

Referring now to FIG. 5, another method 500 is illustrated. The method 500 may be practiced in a computing environment and includes acts for handing errors. The method includes identifying a set including a plurality of explicitly identified failure conditions (act 502).

The method 500 further includes determining that an error condition has occurred that is not in the set including a plurality of explicitly identified failure conditions (act 504). Thus, in contrast to the method 400 illustrated above, the method 500 recites elements for error conditions that are not in a predefined set.

As a result, the method 500 further includes halting a predetermined first execution scope of computing (act 506), and notifying another scope of computing of the failure condition (act 508). As illustrated in FIG. 1, when an error occurs, but is not in a predefined set of error conditions, then the scope 100 can be halted and the agent 108 notified.

The method 500 may further include determining that another error condition has occurred that is in the set including the plurality of explicitly identified failure conditions, and as a result handling the other error condition internally to the first execution scope of computing. For example, an error condition can be handled internally in the scope 100.

The method 500 may further include identifying to a programmer user the set including a plurality of explicitly identified failure conditions to indicate to the programmer user the conditions that will not cause the first scope of computing to fail.

The method 500 may further include identifying to a compiler the set including a plurality of explicitly identified failure conditions to indicate to the compiler failure conditions that do cause a failure of the first execution scope of computing. This can help the programmer to efficiently create application code.

The method 500 may further include the compiler compiling the predetermined first execution scope of computing in an optimized way based on the identified set including a plurality of explicitly identified failure conditions. Compiling the predetermined first execution scope of computing in an optimized way based on the identified set including a plurality of explicitly identified failure conditions may include organizing the code layout of the predetermined first execution scope to improve cache efficiency by moving infrequently used code out of line. Alternatively or additionally compiling the predetermined first execution scope of computing in an optimized way based on the identified set including a plurality of explicitly identified failure conditions may include eliminating redundant control flow based on knowledge by the compiler of the conditions that cause halting the predetermined first execution scope of computing.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method handing errors, the method comprising:
identifying a set including a plurality of explicitly identified failure conditions;
determining that one or more of the explicitly identified failure conditions has occurred; and
as a result, halting a predetermined first execution scope of computing, and notifying another scope of computing of the failure condition.

2. The method of claim 1, wherein the set including a plurality of explicitly identified failure conditions comprises a failure condition indicating that a static invariant requirement of a computing module has been violated.

3. The method of claim 1 further comprising identifying to a programmer user the set including a plurality of explicitly identified failure conditions to indicate to the programmer user failure conditions that can cause a failure of the first execution scope of computing.

4. The method of claim 1 further comprising identifying to a compiler the set including a plurality of explicitly identified failure conditions to indicate to the compiler failure conditions that can cause a failure of the first execution scope of computing.

5. The method of claim 4, further comprising the compiler compiling the predetermined first execution scope of computing in an optimized way based on the identified set including a plurality of explicitly identified failure conditions.

6. The method of claim 5, wherein compiling the predetermined first execution scope of computing in an optimized way based on the identified set including a plurality of explicitly identified failure conditions comprises organizing the code layout of the predetermined first execution scope to improve cache efficiency by moving infrequently used code out of line.

7. The method of claim 5, wherein compiling the predetermined first execution scope of computing in an optimized way based on the identified set including a plurality of explicitly identified failure conditions comprises eliminating redundant control flow based on knowledge by the compiler of the conditions that cause halting the predetermined first execution scope of computing.

8. In a computing environment, a method handing errors, the method comprising:
identifying a set including a plurality of explicitly identified failure conditions;
determining that an error condition has occurred that is not in the set including a plurality of explicitly identified failure conditions; and
as a result halting a predetermined first execution scope of computing, and notifying another scope of computing of the error condition.

9. The method of claim 8, further comprising determining that another error condition has occurred that is in the set including the plurality of explicitly identified failure conditions, and as a result handling the other error condition internally to the first execution scope of computing.

10. The method of claim 8, further comprising identifying to a programmer user the set including a plurality of explicitly identified failure conditions to indicate to the programmer user the conditions that will not cause the first scope of computing to fail.

11. The method of claim 8, further comprising identifying to a compiler the set including a plurality of explicitly identified failure conditions to indicate to the compiler failure conditions that do cause a failure of the first execution scope of computing.

12. The method of claim 8, further comprising the compiler compiling the predetermined first execution scope of computing in an optimized way based on the identified set including a plurality of explicitly identified failure conditions.

13. The method of claim 12, wherein compiling the predetermined first execution scope of computing in an optimized way based on the identified set including a plurality of explicitly identified failure conditions comprises organizing the code layout of the predetermined first execution scope to improve cache efficiency by moving infrequently used code out of line.

14. The method of claim 12, wherein compiling the predetermined first execution scope of computing in an optimized way based on the identified set including a plurality of explicitly identified failure conditions comprises eliminating redundant control flow based on knowledge by the compiler of the conditions that cause halting the predetermined first execution scope of computing.

15. In a computing environment, a computer readable storage medium comprising computer executable instructions that when executed by one or more processors cause the one or more processor to perform the following:
identifying a set including a plurality of explicitly identified failure conditions;
determining that an error condition has occurred that is not in the set including a plurality of explicitly identified failure conditions; and
as a result halting a predetermined first execution scope of computing, and notifying another scope of computing of the failure condition.

16. The computer readable storage medium of claim 15, further comprising computer executable instructions that when executed by one or more processors cause one or more processors to determine that another error condition has occurred that is in the set including the plurality of explicitly identified failure conditions, and as a result handle the another error condition internally to the first execution scope of computing.

17. The computer readable storage medium of claim 15, further comprising computer executable instructions that when executed by one or more processors cause one or more processors identify to a compiler the set including a plurality of explicitly identified failure conditions to indicate to the compiler failure conditions that do cause a failure of the first execution scope of computing.

18. The computer readable storage medium of claim 17, wherein the compiler compiles the predetermined first execution scope of computing in an optimized way based on the identified set including a plurality of explicitly identified failure conditions.

19. The computer readable storage medium of claim 18, wherein compiling the predetermined first execution scope of computing in an optimized way based on the identified set including a plurality of explicitly identified failure conditions comprises organizing the code layout of the predetermined first execution scope to improve cache efficiency by moving infrequently used code out of line.

20. The computer readable storage medium of claim 18, wherein compiling the predetermined first execution scope of computing in an optimized way based on the identified set including a plurality of explicitly identified failure conditions comprises eliminating redundant control flow based on knowledge by the compiler of the conditions that cause halting the predetermined first execution scope of computing.
